(19) United States
(12) Patent Application Publication
(10) Pub. No.: US 2008/0258124 A1
(43) Pub. Date: Oct. 23, 2008

(54) Winch

(76) Inventor: Alexander James Farmer, Polokwane (ZA)

Correspondence Address: FROMMER LAWRENCE & HAUG, 745 FIFTH AVENUE- 10TH FL., NEW YORK, NY, 10151, US

(21) Appl. No.: 11/913,452

(22) PCT Filed: Apr. 21, 2006
(86) PCT No.: PCT/IB2006/000958

§ 371 Date: Apr. 29, 2008

(30) Foreign Application Priority Data
May 4, 2005 (ZA) 2005/03545

(51) Int. Cl. B66D 1/38

(52) U.S. Cl. 254/323

(57) ABSTRACT

The invention concerns a winch (10) comprising a hub (14) about which a length of cable (16) can be wound when the hub is caused to rotate. The winch of the invention includes a guiding system (22) for distributing the cable about the hub and a drive assembly (24) connected to the guiding system. The drive assembly has a first drive configuration and a second drive configuration wherein the first drive configuration will cause the guiding system to distribute the cable in a first direction about the hub and the second drive configuration will cause the guiding system to distribute cable in a second direction about the hub. The winch of the invention further also includes a switch (28) for switching the drive assembly between its first and second drive configurations. The invention also extends to a guiding arrangement for retro-fitment to a hub of an existing winch.

### BACKGROUND TO THE INVENTION

THIS invention relates to a winch. In particular the invention is concerned with a winch for off-road vehicles wherein the winch includes a guiding system for controlling rewinding of a cable onto a hub of the winch.

People enjoying exploring the outdoors normally own off-road vehicles with which they can explore areas of nature which are not accessible to normal road vehicles. As it often happens that off-road vehicles get stuck when rough terrain is traversed, these vehicles are typically equipped with winches which can be used to pull stuck vehicles free.

A winch for an off-road vehicle usually comprises a hub about which a length of cable can be wound and an electrical motor for powering the winch when the cable is to be rewound. The cable normally has a hook at its one end which can be secured to stationary objects. When the winch is to be used to free a stuck vehicle, a length of cable is unwound from the hub and secured to a nearby object such as a tree, whereafter the motor of the winch is activated. The cable is now rewound about the hub of the winch and the vehicle is pulled from its position as the length of unwound cable becomes shorter. Rewinding of the cable continues until the vehicle becomes unstuck.

A problem which is currently experienced with existing winches is that it is very difficult to rewind the cable in an equally distributed and neat fashion onto the hub while the cable is under stress of a vehicle being pulled from a stuck position. In some instances a vehicle owner may in desperation guide the cable with his hands which is very likely to cause an injury. In cases where a vehicle is stuck and the cable is to be secured at a right angle relative to the vehicle, the cable will normally be wound in a bunch at one end of the hub. In severe cases the cable will be destroyed after such an incident and the winch tie rods, which secure the winch via mounting posts to the vehicle, severely damaged.

It is an object of the invention to address the above problems associated with the rewinding of a cable onto a winch.

### SUMMARY OF THE INVENTION

According to a first aspect of the present invention there is provided a winch comprising:
a hub about which a length of cable can be wound when the hub is caused to rotate;
a guiding system for distributing the cable about the hub;
a drive assembly connected to the guiding system, the drive assembly having a first drive configuration and a second drive configuration wherein the first drive configuration will cause the guiding system to distribute the cable in a first direction about the hub and the second drive configuration will cause the guiding system to distribute cable in a second direction about the hub; and
a switch for switching the drive assembly between its first and second drive configurations.

Preferably the winch includes driving means for conveying rotational movement from the hub to the drive assembly.

Typically the driving means comprises a first sprocket which is connected to the hub, a second sprocket which is connected to the drive assembly, and a chain connecting the two sprockets.

Advantageously the guiding system comprises a guide shaft having a threaded portion and a guide block, having a threaded portion for engaging the guide shaft, such that rotation of the guide shaft will cause the guide block to move along the guide shaft.

In an embodiment of the invention the first drive configuration of the drive assembly comprises a first and a second drive assembly sprocket which are connected with a chain. The second drive configuration of the embodiment comprises a first and a second gear which engage one another. Both the first and the second drive configurations are connected to the guide shaft such that when the switch engages the first drive configuration the guide shaft will rotate in a first direction thereby causing the guide block to move along the guide shaft in a first direction. Furthermore, when the switch engages the second drive configuration the guide shaft will rotate in a second direction and consequently the guide block will move in a second direction along the guide shaft.

Preferably the switch includes a selector for engaging either the first drive configuration or the second drive configuration.

Typically the switch includes sensors for detecting the location of the guide block on the guide shaft.

Preferably the switch includes a solenoid such that by changing the polarity of the solenoid the selector will engage either the first drive configuration or the second drive configuration.

In an alternative embodiment the selector is manually operable by a user who can monitor movement of the guide block along the guide shaft.

Typically the guiding system will include a number of support rods for supporting movement of the guide block along the guide shaft.

According to a further aspect of the invention there is provided a cable guiding arrangement for a winch having a hub about which a length of cable can be wound, the cable guiding arrangement comprising:
a guiding system for distributing the cable about the hub;
a drive assembly connected to the guiding system, the drive assembly having a first drive configuration and a second drive configuration wherein the first drive configuration will cause the guiding system to distribute the cable in a first direction about the hub and the second drive configuration will cause the guiding system to distribute cable in a second direction about the hub; and
a switch for switching the drive assembly between its first and second drive configurations.

### BRIEF DESCRIPTION OF THE DRAWINGS

The invention will now be described in more detail, by way of example only, with reference to the accompanying drawings wherein:

FIG. 1 shows a perspective view of a winch in accordance with the invention connected to an off-road vehicle,

FIG. 2 shows an enlarged perspective view of the winch; and

FIG. 3 shows a cross-sectional view of the winch.

### DESCRIPTION OF THE ILLUSTRATED EMBODIMENT

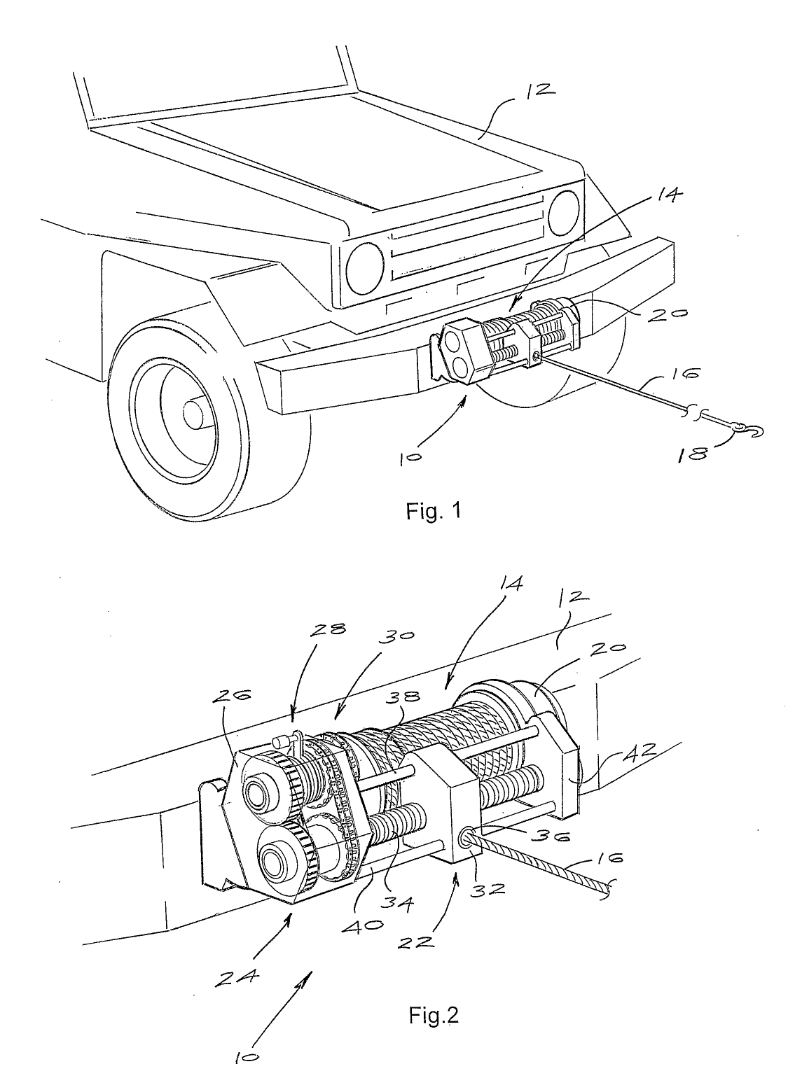

FIG. 1 and FIG. 2 show a winch in accordance with the invention, generally indicated with the reference numeral 10, installed on an off-road vehicle 12. The winch 10 includes a hub 14 about which a cable 16 is wound. As shown in FIG. 1, the cable 16 is partially unwound and includes a hook 18 at one end. The hook 18 can be used to secure the cable 16 to a stationary object, such as a tree, when the off-road vehicle 12 is to be pulled free from a stuck position. The hub 14 is connected to an electrical motor 20 such that when it is required to rewind the cable 16, the electrical motor 20 will drive the hub 14 causing it to rotate, thereby winding the cable about the hub 14.

As shown in FIG. 2, the winch of the invention comprises a guiding system 22, a drive assembly 24 enclosed inside a housing 26 and a switch 28. The winch 10 also includes a driving means 30 for conveying rotational movement from the hub 14 to the drive assembly 24.

The guiding system 22 of this embodiment of the invention comprises a guide block 32 which includes a threaded portion, not shown, for engaging a threaded guide shaft 34. The guide block 32 includes a guide hole 36 at its front and another guide hole at its rear, not visible in the drawings, for guiding the cable 16 through the guide block 32 and onto the hub 14. The guiding system 22 further also includes two support rods 38 and 40 which pass slidably through the guide block 32 and are secured to the housing 26 at one end and to a mounting post 42 at their other ends.

It is pointed out that the pitch of the threaded portion of the guide shaft 34 will correspond to the thickness of the cable to be wound around the hub 14 in order to prevent lagging of the guide block 32 relative to the position of the cable 16 on the hub 14 as will be described below.

In order to rewind the cable 16 about the hub 14, the electrical motor 20 will be activated such that the hub 14 will rotate. Simultaneous to the hub 14 rotating the drive means 30 will impart drive to the drive assembly 24 which in turn will cause the guide shaft 34 to rotate in a first direction. Rotation of the guide shaft 34 will cause the guide block 32 to move in a first direction relative to the hub 14 thereby distributing the cable 16 evenly about the hub along the first direction. When the guide block 32 reaches the end of the guide shaft 34, the switch 28 will cause the drive assembly 24 to rotate the guide shaft 34 in a second direction, as will be described below. The guide block 32 will now move in a second direction along the guide shaft 34 thereby distributing the cable 16 evenly in a second direction along the hub 14.

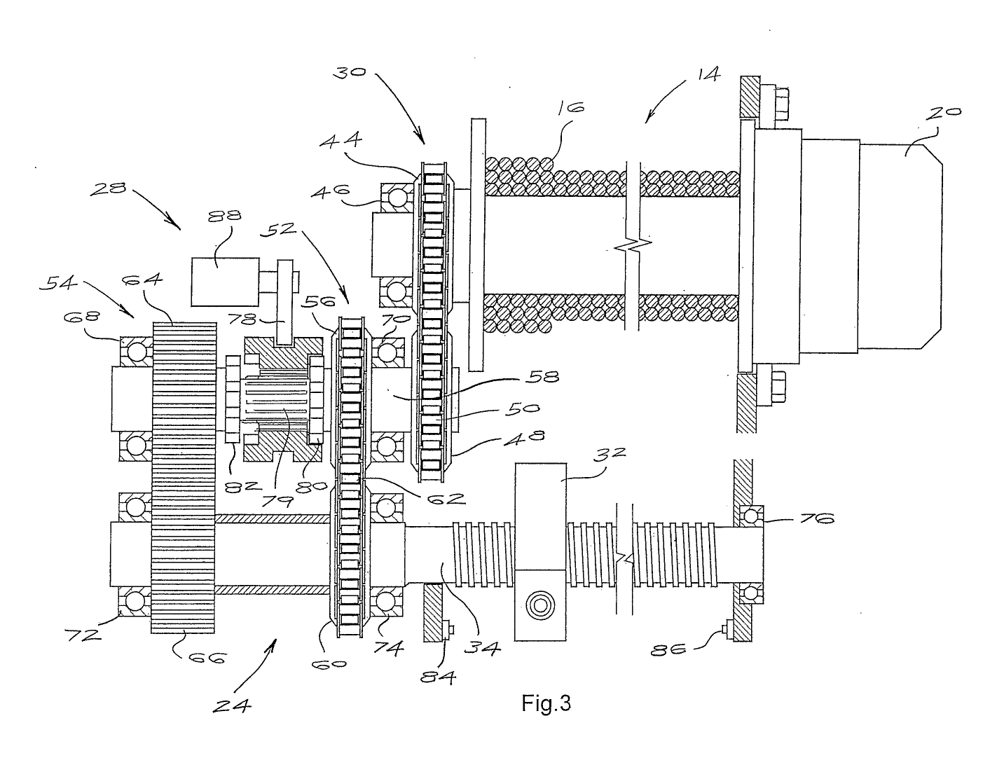

The operation of the drive assembly 24 and the driving means 30 will be described with reference to FIG. 3 of the drawings. In this embodiment of the invention the driving means 30 comprises a first sprocket 44 which is connected to the hub 14. The hub 14 and first sprocket 44 is supported by the electrical motor 20 at one end and a bearing 46 at another end. The first sprocket 44 is connected to a second sprocket 48 by way of a chain 50 as shown. The second sprocket 48 in turn is connected to the drive assembly 24. When the hub 14 is now caused to rotate due to operation of the electrical motor 20, the first sprocket 44 will also rotate and this rotational movement will be conveyed to the second sprocket 48, and as a consequence to the drive assembly 24, via the chain 50.

The drive assembly 24 comprises a first and a second drive configuration, generally indicated with the reference numerals 52 and 54 respectively. The first drive configuration 52 comprises a first drive assembly sprocket 56, secured about a drive assembly shaft 58, and a second drive assembly sprocket 60, which is secured to the guide shaft 34. The first and second drive assembly sprockets 56 and 60 are connected to each other by way of a drive assembly chain 62. It is pointed out that the first drive assembly sprocket 56 can rotate freely about the drive assembly shaft 58 while the second drive assembly sprocket 60 is secured to the guide shaft 34 in such a manner that no relative movement is possible.

The second drive configuration 54 comprises a first gear 64 which is secured about the drive assembly shaft 58, and a second gear 66 which is secured on the guide shaft 34. The teeth of the first and second gear 64 and 66 mesh so that rotation of the first gear 64 will induce rotation in the second gear 66. It is also pointed out that the first gear 64 can rotate freely about the drive assembly shaft 58 while the second gear 66 is secured to the guide shaft 34 such that no relative movement is possible.

As shown the first drive assembly sprocket 56 and the first gear 64 is secured about the drive assembly shaft 58 by way of two bearings 68 and 70, while the guide shaft 34 is secured in position by way of three bearings indicated respectively with the reference numerals 72, 74 and 76.

In order to cause the guide block 32 to move along the guide shaft 34, either the first or the second drive configuration 52 and 54 must drive the guide shaft 34 so that it rotates in either a first or a second direction. In order to engage one of the drive configurations the switch 28 is provided with a selector 78 which is connected to a splined portion 79 on the drive assembly shaft 58. Both the first drive assembly sprocket 56 and the first gear 64 includes a synchronising gear, indicated with the reference numerals 80 and 82 respectively, for facilitating the transfer of drive from the drive assembly shaft 58 as will be described below.

Before describing the operation of the winch 10 it is pointed out that the switch comprises two proximity sensors 84 and 86 for detecting the guide block 32. The switch 28 also includes a solenoid 88. By changing the polarity of the solenoid 88 the selector 78 will either engage the first drive assembly sprocket 56 or the first gear 64.

In use the drive assembly shaft 58 will be driven by the chain 50, which imparts rotation thereon via the second sprocket 48, in a first direction. In order also to rotate the guide shaft 34 in the first direction the selector 78 will engage the first drive assembly sprocket 56 of the first drive configuration 52 such that the second drive assembly sprocket 60 can drive the guide shaft 34 also in the first direction. The guide block 32 will now move from left to right along the guide shaft 34 while distributing the cable 16 about the rotating hub 14. It is pointed out that while the first drive assembly sprocket 56 is engaged, the first gear 64 will rotate freely. When the guide block 32 has moved a sufficient distance along the guide shaft 34, the proximity sensor 86 will detect its presence and cause the solenoid 88 to change its polarity such that the selector 78 will move from the first drive assembly sprocket 56 and engage the first gear 64 of the second drive configuration 54.

With the first gear 64 engaged by the selector 78, rotation of the chain 50 in the first direction will be conveyed via the drive assembly shaft 58 to the first gear 64. It is pointed out that with the first gear 64 engaged by the selector 78, the first drive assembly sprocket 56 will rotate freely. Due to the fact that the first gear 64 meshes with the second gear 66, rotation of the first gear 64 in the first direction will cause the second gear 66 to rotate in a second direction, consequently causing the guide shaft 34 also to rotate in the second direction. The guide block 32 will now move from the right side of the guide shaft 34 towards the left side while distributing the cable 16 about the rotating hub 14. When the guide block 32 has moved a sufficient distance along the guide shaft 34 it will be detected by the proximity sensor 84 thereby again causing a change in the polarity of the solenoid 88 and a consequential move of the selector 78 from the second drive configuration 54 to the first drive configuration 52. This process will continue until the cable 16 is completely wound about the hub 14.

Although not specifically shown in the drawings, it will be appreciated that the drive assembly, guiding system and switch as described above can with minor modifications be retrofitted to a standard winch. In the case where an existing winch having a hub is to be converted into a winch in accordance with the invention a cable guiding arrangement is provided which will comprise firstly a guiding system for distributing a length of cable about the hub of the winch and secondly a drive assembly for connection to the guiding system, the drive assembly having a first drive configuration and a second drive configuration wherein the first drive configuration will cause the guiding system to distribute the cable in a first direction about the hub and the second drive configuration will cause the guiding system to distribute cable in a second direction about the hub. Finally the cable guide arrangement will also include a switch for switching the drive assembly between its first and second drive configurations.

Although not specifically described above it will be appreciated that the winch and the cable guiding arrangement of the invention could find application in a range of winches, for example in industrial winches as well as in winches used at underground mines.

By providing a guiding system which can distribute a cable evenly about a hub of a winch, specifically when the cable is secured at right angles relative to a vehicle, the problems which are experienced when winching with existing winches are addressed.

1. A winch comprising:
a hub about which a length of cable can be wound when the hub is caused to rotate;
a guiding system for distributing the cable about the hub;
a drive assembly connected to the guiding system, the drive assembly having a first drive configuration and a second drive configuration wherein the first drive configuration will cause the guiding system to distribute the cable in a first direction about the hub and the second drive configuration will cause the guiding system to distribute cable in a second direction about the hub; and
a switch for switching the drive assembly between its first and second drive configurations.

2. A winch according to claim 1 including driving means for conveying rotational movement from the hub to the drive assembly.

3. A winch according to claim 2 wherein the driving means comprises a first sprocket which is connected to the hub, a second sprocket which is connected to the drive assembly, and a chain which connects the first and second sprockets.

4. A winch according to claim 1 wherein the guiding system comprises a guide shaft having a threaded portion and a guide block having a threaded portion for engaging the guide shaft wherein rotation of the guide shaft will cause the guide block to move along the guide shaft.

5. A winch according to claim 4 wherein the first and the second drive configurations are connected to the guide shaft such that when the switch engages the first drive configuration the guide shaft will rotate in a first direction thereby causing the guide block to move along the guide shaft in a first direction, and when the switch engages the second drive configuration the guide shaft will rotate in a second direction consequently causing the guide block to move in a second direction along the guide shaft.

6. A winch according to claim 1 wherein the first drive configuration of the drive assembly comprises a first and a second drive assembly sprocket, the first and second drive assembly sprockets being connected with a chain.

7. A winch assembly according to claim 1 wherein the second drive configuration comprises a first and a second gear which engage one another.

8. A winch according to claim 1 wherein the switch includes a selector for engaging either the first drive configuration or the second drive configuration.

9. A winch according to claim 4 wherein the switch includes sensors for detecting the location of the guide block on the guide shaft.

10. A winch according to claim 8 wherein the switch includes a solenoid such that by changing the polarity of the solenoid the selector will engage either the first drive configuration or the second drive configuration.

11. A winch according to claim 8 wherein the selector is manually operable by a user who can monitor movement of the guide block along the guide shaft.

12. A winch according to claim 4 wherein the guiding system includes at least one support rod for supporting movement of the guide block along the guide shaft.

13. A cable guiding arrangement for a winch having a hub about which a length of cable can be wound, the cable guiding arrangement comprising:
a guiding system for distributing the cable about the hub;
a drive assembly for connection to the guiding system, the drive assembly having a first drive configuration and a second drive configuration wherein the first drive configuration will cause the guiding system to distribute the cable in a first direction about the hub and the second drive configuration will cause the guiding system to distribute cable in a second direction about the hub; and
a switch for switching the drive assembly between its first and second drive configurations.
